(19) United States
(12) Patent Application Publication
(10) Pub. No.: US 2009/0169818 A1
(43) Pub. Date: Jul. 2, 2009

(54) ANTI-FOULING COATING COMPRISING NANOSCALE HYDROPHOBIC PARTICLES AND METHOD OF PRODUCING IT

(75) Inventor: Werner Michel, Lützelbach (DE)

Correspondence Address: OBLON, SPIVAK, MCCLELLAND MAIER & NEUSTADT, P.C., 1940 DUKE STREET, ALEXANDRIA, VA, 22314, US

(73) Assignee: EVONIK DEGUSSA GmbH, Essen (DE)

(21) Appl. No.: 12/304,504

(22) PCT Filed: May 29, 2007
(86) PCT No.: PCT/EP07/55200

§ 371 Date: Dec. 12, 2008

(30) Foreign Application Priority Data
Jun. 29, 2006 (DE) 10 2006 030 054.8

(51) Int. Cl. B32B 5/16; B05D 3/10

(52) U.S. Cl. 428/148; 427/385.5

(57) ABSTRACT

Anti-fouling coating consisting of a resinous binder layer comprising nanoscale hydrophobic particles, —the particles not only being located in the binder layer but also protruding from it, —the particle/binder ratio being 2.5 to 5, and—the particle concentration of the binder layer being 0.01 to 1 g/m².

The invention relates to an anti-fouling coating, to a method of producing it and to its use.

The principle of self-cleaning coatings which are in contact with atmospheric air and on which water acts only occasionally is general knowledge. In order for effective surface self-cleaning to be achieved, these coatings must have not only a highly hydrophobic surface but also a certain roughness. An appropriate combination of structure and water repellency makes it possible for even small amounts of moving water on the surface to entrain adhering dirt particles and clean the surface (WO 96/04123; U.S. Pat. No. 3,354,022).

From EP-A-933388 it is known, moreover, that for self-cleaning surfaces of this kind an aspect ratio of >1 and a surface energy of less than 20 mN/m are required. The aspect ratio here is defined as the ratio of height to the width of the structure. Aforementioned criteria are realized in nature, as for example in the lotus leaf. The surface of the plant, formed from a hydrophobic, wax-like material, has elevations at a distance of a few μm from one another. Water drops come into contact essentially only with the tips of the elevations. Water-repellent surfaces of this kind are described for example in EP-A-909747, WO 00/58410 or U.S. Pat. No. 5,599,489.

A need for surfaces modified in this way exists not only in the case of articles which are surrounded by atmospheric air but also, in particular, in connection with the operation of articles around the whole or part of which water passes, in order to hinder their population by aquatic organisms. These articles may be, for example, walls, container surfaces, bulkheads, platforms, posts and other load-bearing constructions which are in long-term contact with either fresh or salt water. The population pressure under water is very great. For instance, there are larvae and spores of around 6000 species of marine bionts known which settle on solid surfaces for the purpose of growing up permanently on them.

The secretions of the adhering organisms may promote the corrosion of the materials. In particular, the contour of a ship's body is altered in such a way by the three-dimensionally projecting infestation that the flow resistance is increased by an average of around 15%, resulting in a higher fuel consumption.

As a remedy, biocidal paints are applied in order to kill or repel the larvae and spores of the unwanted organisms. Included here are coatings which comprise leachable substances that are toxic to aquatic organisms. Such compounds may be organic in nature, such as chlorinated aromatic hydrocarbons such as DDT, for example, or they may be inorganic in nature, such as copper oxide or copper thiocyanate, for example, or else may be organometallic compounds, such as alkyl borates or alkyltin compounds, for example.

A disadvantage of these prior-art biocidal paints is that the substances leached from them, over long periods of time, may contaminate the water and the sediments of the bodies of water and hence may develop unwanted harmful effects. A further disadvantage is that the protective coating present must be removed at regular intervals and replaced by a new coat. This leads to disposal costs for the non-standard waste produced, to costs for the new coating material, and to labour costs.

In order to avoid these disadvantages, there exist methods in the prior art which are intended to halt the unwanted biofouling without toxins, by means of physical effects. These may be coatings of gel-like silicone polymers on a ship's hull, or the application of a hide-like fabric whose fibres, by virtue of their movements during slow travel, prevent colonization by the larvae.

Although these latter techniques do avoid toxic compounds, they are complicated to produce and apply or, owing to the materials concerned, are expensive, and they therefore remain limited to special cases.

It was an object of the present invention, therefore, to provide a method of producing anti-fouling coatings that allows the surfaces of articles to be treated with a very thin, permanent coating which is stable in service and sparing in its use of material.

The invention provides an anti-fouling coating consisting of a resinous binder layer comprising nanoscale hydrophobic particles,
the particles not only being located in the binder layer but also protruding from it,
the particle/binder ratio being 2.5 to 5, and
the particle concentration of the binder layer being 0.01 to 1 g/m².

For the purposes of the invention, anti-fouling means that the colonization of the article's surface by molluscs and by algae that grow to a large size is reduced or prevented entirely.

The coating of the invention is a permanent coating. By permanent is meant that, in flowing water over a long time period, the coating of the invention cannot be detached from the article. The duration of service depends on the composition of the water and on the water temperature.

The thickness of the coating of the invention can be varied within wide limits. In general, including the particles protruding from it, the thickness of the coating is 0.1-100 μm.

The hydrophobic properties of the nanoscale particles may be present inherently, as for example in the case of polytetrafluoroethylene (PTFE). It is also possible, however, to use hydrophilic particles which exhibit hydrophobic properties only after an appropriate treatment.

Nanoscale hydrophobic particles used may be silicates, minerals, metal oxide powders, metal powders, pigments and/or polymers.

It is possible with preference to use nanoscale hydrophobic metal oxide particles.

With particular advantage it is possible to use pyrogenically produced metal oxide particles having a BET surface area of 20 to 400 m²/g and in particular of 35 to 300 m²/g. Pyrogenically produced metal oxide particles for the purposes of the invention encompass aluminium oxide, silicon dioxide, titanium dioxide and/or zinc oxide, and also mixed oxides of the aforementioned compounds.

By pyrogenic, or fumed, metal oxide particles are meant those obtained by flame oxidation and/or flame hydrolysis. In these procedures, oxidizable and/or hydrolysable starting materials are generally oxidized in an oxyhydrogen flame or hydrolysed. Starting materials used for pyrogenic methods may include organic and inorganic substances. Particularly suitable, for example, are the readily available chlorides, such as silicon tetrachloride, aluminium chloride or titanium tetrachloride. Suitable organic starting compounds may for example be alkoxides, such as Si(OC₂H₅)₄, Al(OiC₃H₇)₃ or Ti(OiPr)₄. The resulting metal oxide particles are very largely pore-free and have free hydroxyl groups on the surface. In general the pyrogenic metal oxide particles are at least partly in the form of aggregated primary particles. In the present invention, metalloid oxides, such as silicon dioxide, for example, are termed metal oxides.

The pyrogenic metal oxides acquire their hydrophobic properties through surface modifier reagents which react with active groups on the surface. For this purpose it is possible with preference to use the following silanes, individually or as a mixture:

Organosilanes (RO)₃Si(CₙH₂ₙ₊₁) and (RO)₃Si(CₙH₂ₙ₋₁)

with R=alkyl, such as methyl, ethyl, n-propyl, isopropyl, butyl and n=1-20.

Organosilanes R′ₓ(RO)_{y}Si(CnH₂ₙ₊₁) and R′ₓ(RO)_{y}Si(CₙH₂ₙ₋₁)

with R=alkyl, such as methyl, ethyl, n-propyl, isopropyl, butyl; R′=alkyl, such as methyl, ethyl, n-propyl, isopropyl, butyl; R′=cycloalkyl; n=1-20; x+y=3, x=1, 2; y=1, 2.

Haloorganosilanes X₃Si(CₙH₂ₙ₊₁) and X₃Si(CₙH₂ₙ₋₁)

with X=Cl, Br; n=1-20.

Haloorganosilanes X₂(R′)Si(CₙH₂ₙ₊₁) and X₂(R′)Si(CₙH₂ₙ₋₁)

with X=Cl, Br, R′=alkyl, such as methyl, ethyl, n-propyl, isopropyl, butyl-; R′=cycloalkyl; n=1-20.

Haloorganosilanes X(R′)₂Si(CₙH₂ₙ₊₁) and X(R′)₂Si(CₙH₂ₙ₋₁)

with X=Cl, Br; R′=alkyl, such as methyl-, ethyl-, n-propyl-, isopropyl-, butyl-; R′=cycloalkyl; n=1-20.

Organosilanes (RO)₃Si(CH₂)ₘ—R′

with R=alkyl, such as methyl-, ethyl-, propyl-; m=0.1-20, R′=methyl, aryl such as —C₆H₅, substituted phenyl radicals, C₄F₉, OCF₂—CHF—CF₃, C₆F₁₃, OCF₂CHF₂, Sₓ—(CH₂)₃Si(OR)₃.

Organosilanes (R″)ₓ(RO)_{y}Si(CH₂)ₘ—R′

with R″=alkyl, x+y=3; cycloalkyl, x=1, 2, y=1, 2; m=0.1 to 20; R′=methyl, aryl, such as C₆H₅, substituted phenyl radicals, C₄F₉, OCF₂—CHF—CF₃, C₆F₁₃, OCF₂CHF₂, Sₓ—(CH₂)₃Si(OR)₃, SH, NR′R″R′″ with R′=alkyl, aryl; R″=H, alkyl, aryl; R′″=H, alkyl, aryl, benzyl, C₂H₄NR″″R′″″ with R″″=H, alkyl and R′″″=H, alkyl.

Haloorganosilanes X₃Si (CH₂)ₘ—R′

X=Cl, Br; m=0.1-20; R′=methyl, aryl such as C₆H₅, substituted phenyl radicals, C₄F₉, OCF₂—CHF—CF₃, C₆F₁₃, O—CF₂—CHF₂, Sₓ—(CH₂)₃Si(OR)₃, where R=methyl, ethyl, propyl, butyl and x=1 or 2, SH.

Haloorganosilanes RX₂Si(CH₂)ₘR′

X=Cl, Br; m=0.1-20; R′=methyl, aryl such as C₆H₅, substituted phenyl radicals, C₄F₉, OCF₂—CHF—CF₃, C₆F₁₃, O—CF₂—CHF₂, —OOC(CH₃)C═CH₂, —Sₓ—(CH₂)₃Si(OR)₃, where R=methyl, ethyl, propyl, butyl and x=1 or 2, SH.

Haloorganosilanes R₂XSi(CH₂)ₘR′

X=Cl, Br; m=0.1-20; R′=methyl, aryl such as C₆H₅, substituted phenyl radicals, C₄F₉, OCF₂—CHF—CF₃, C₆F₁₃, O—CF₂—CHF₂, —Sₓ—(CH₂)₃Si(OR)₃, where R=methyl, ethyl, propyl, butyl and x=1 or 2, SH.

Silazanes R′R₂SiNHSiR₂R′ with R,R′=alkyl, vinyl, aryl.

Cyclic polysiloxanes D3, D4, D5 and their homologs, with D3, D4 and D5 meaning cyclic polysiloxanes having 3, 4 or 5 units of the type —O—Si(CH₃)₂, e.g. octamethylcyclotetrasiloxane=D4.

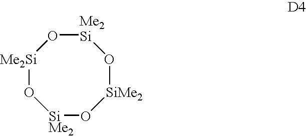

Polysiloxanes or silicone oils of the type

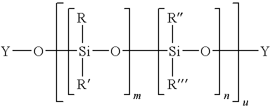

with R=alkyl,
R′=alkyl, aryl, H
R″=alkyl, aryl
R′″=alkyl, arylH
Y=CH₃, H, C_{z}H_{2z+1}, with z=1-20,
   Si(CH₃)₃, Si(CH₃)₂H, Si(CH₃)₂OH, Si(CH₃)₂(OCH₃), Si(CH₃)₂(C_{z}H_{2z+1})
where
R′ or R″ or R′″ is (CH₂)_{z}—NH₂ and
z=1-20, m=0, 1, 2, 3, . . . ∞, n=0, 1, 2, 3, . . . ∞,
u=0, 1, 2, 3, . . . ∞.

As surface modifiers it is possible with preference to use the following compounds: octyltrimethoxysilane, octyltriethoxysilane, hexamethyldisilazane, 3-methacryloyloxypropyltrimethoxysilane, 3-methacryloyloxypropyltriethoxysilane, hexadecyltrimethoxysilane, hexadecyltriethoxysilane, dimethylpolysiloxane, nonafluorohexyltrimethoxysilane, tridecafluorooctyltrimethoxysilane, tridecafluorooctyltriethoxysilane.

With particular preference it is possible to use hexamethyldisilazane, octyltriethoxysilane and dimethylpolysiloxanes.

Suitable hydrophobic, pyrogenic metal oxides can be selected for example from the table of stated AEROSIL® and AEROXIDE® products (all from Degussa).

TABLE
Hydrophobic metal oxides

| | BET | | | |
|---|---|---|---|---|
| | surface | Loss on | | Carbon |
| | area | drying | | contents |
| Type | [m²/g] | [wt. %] | pH | [wt. %] |
| AEROSIL ® | | | | |
| R 972 | 110 ± 20 | ≦0.5 | 3.6-4.4 | 0.6-1.2 |
| R 974 | 170 ± 20 | ≦0.5 | 3.7-4.7 | 0.7-1.3 |
| R 104 | 150 ± 25 | — | ≧4.0 | 1.0-2.0 |
| R 106 | 250 ± 30 | — | ≧3.7 | 1.5-3.0 |
| R 202 | 100 ± 20 | ≦0.5 | 4.0-6.0 | 3.5-5.0 |
| R 805 | 150 ± 25 | ≦0.5 | 3.5-5.5 | 4.5-6.5 |
| R 812 | 260 ± 30 | ≦0.5 | 5.5-7.5 | 2.0-3.0 |
| R 816 | 190 ± 20 | ≦1.0 | 4.0-5.5 | 0.9-1.8 |
| R 7200 | 150 ± 25 | ≦1.5 | 4.0-6.0 | 4.5-6.5 |
| R 8200 | 160 ± 25 | ≦0.5 | ≧5.0 | 2.0-4.0 |
| R 9200 | 170 ± 20 | ≦1.5 | 3.0-5.0 | 0.7-1.3 |
| AEROXIDE ® | | | | |
| TiO₂ T805 | 45 ± 10 | — | 3.0-4.0 | 2.7-3.7 |
| TiO₂ NKT90 | 50-75 | — | 3.0-4.0 | 2.0-4.0 |
| Alu C 805 | 100 ± 15 | — | 3.0-5.0 | — |

The resinous binder layer of the coating of the invention is preferably a hydrophobic synthetic polymer or a blend of such.

The invention further provides a method of producing the coating of the invention, wherein a preparation comprising nanoscale hydrophobic particles and also, if desired, fillers and pigments and at least one binder is applied to at least one surface of an article and then cured.

The binders may be air-drying, they may be free-radically crosslinking by peroxides or chemically crosslinking by condensation reaction or addition reaction, or they may be made radiation-crosslinking, crosslinking for example by light or ultraviolet radiation.

Binders which can be used include monomers, low molecular mass prepolymers, high molecular mass polymers, and mixtures thereof. Thus, for example, it is possible to use the following: acryloylmorpholine, methyl acrylate, ethyl acrylate, ethylcarbitol acrylate, 1,6-hexanediol acrylate, propyl acrylate, isopropyl acrylate, isobornyl acrylate, butyl acrylate, isobutyl acrylate, tert-butyl acrylate, cyclohexyl acrylate, dipentaerythritol tetraacrylate and its ethoxylated and/or propoxylated derivatives, hexyl acrylate, neopentyl acrylate, ethylene glycol acrylate, triethylene glycol acrylate, trimethylolpropane triacrylate and its ethoxylated and/or propoxylated derivatives, octyl acrylate, pentaerythritol tetraacrylate, phenoxyethyl acrylate, isooctyl acrylate, isobornyl methacrylate, methyl methacrylate, ethyl methacrylate, neopentyl glycol acrylate, isopropyl methacrylate, butyl methacrylate, isobutyl methacrylate, cyclohexyl methacrylate, ethylene glycol dimethacrylate, triethylene glycol dimethacrylate, hexyl methacrylate, octyl methacrylate, pentaerythritol tetramethacrylate, isooctyl methacrylate, neopentyl glycol methacrylate, styrene, methylstyrene, cyclopentadiene, vinyl acetate, vinyl chloride, vinylcaprolactam, and the copolymers prepared from the stated monomers, and/or caprolactam.

In addition it is possible as binders to use epoxy resins, epoxidized novolak resins, polyester resins, silicone resins, vinyl ester resins, isocyanate resins, and their crosslinkers, or curing components, selected from amines, amides, carboxylic anhydrides, mercaptans, polyols, peroxides and their catalysts, selected from compounds of elements from main groups 1 to 4 and their transition groups and from transition group eight.

Photoinitiators which can be used are all customary systems, especially acetophenone, organically substituted phosphine oxides, bisacylphosphine oxides, such as Irgacure 801, Irgacure 2005, oxime esters, thiazolium salts, thioether ketones, triphenylsulphonium hexafluoroantimonates, and nanoparticulate semiconductors of the metal oxide or metal sulphide type, such as ZnO or CdS, for example.

In addition the preparation may also comprise customary fillers. These include fillers from naturally occurring deposits, such as talc, finely ground mica, graphite, kieselguhr, kaolin, calcium carbonate, calcium silicate, finely ground quartz, or heavy spar, or the fillers may be synthetically produced, such as wet-precipitated silica, sodium aluminium silicate, aluminium oxide hydrate, carbon black, finely ground glass, and hollow glass beads, for example. Also included may be natural or synthetic short fibres, such as cellulose fibres, wollastonite, polypropylene fibres or polyamide fibres, for example.

The fillers and fibres may have been surface-modified in order to obtain a chemical functionality or a compatibilization with the binder. The surface modifiers recited above are suitable for this surface modification.

Some or all of the fillers may be replaced by pigments, if colouring of the anti-fouling layer is desired.

In addition it is possible for metals from group Ib, III or IV of the Periodic Table to be present, examples being the oxides, hydroxides, oxychlorides, acetates, maleates and stearates. A large number of such biocidal compounds are known and are used for producing biostatic surfaces. The efficacy of biocides of this kind may be increased in combination with the coating of the invention, thereby making it possible to reduce their concentration as compared with the prior art.

The preparation may further comprise a volatile solvent in which the binder is present in solution. The volatile solvent is removed after the preparation has been applied. The removal of the volatile solvent is accomplished by evaporation or volatilization, which may be accelerated through the use of elevated temperatures, through air extraction or through the use of subatmospheric pressure or reduced pressure. Volatile means that at least 95% of the solvent has evaporated within 24 hours at 25° C.

The fraction of the nanoscale hydrophobic particles used in the preparation is preferably 0.5% to 15% by weight, based on the total amount of the solid and liquid constituents of the preparation. Particular preference is given to a range from 1% to 10% by weight.

As volatile solvents in this sense the preparation may comprise one or more hydrocarbons, esters and ketones, and alcohols that are liquid under standard conditions, having a boiling range of 36° C. to 240° C., preferably of 120° C. to 200° C., alone or in a blend with one another.

The fraction of these compounds in the preparation is preferably up to 99% by weight of the total amount of the liquid and solid constituents of the preparation. Particular preference is given to a range from 80% to 98% by weight.

For the method of the invention the preparation may further comprise a propellant gas, such as a butane/propane mixture. Accommodated in a pressurized gas container, this form of the preparation is suitable for spray application to the surface of the article to be treated.

The concentration of hydrophobic particles, based on the total liquid volume in the pressure vessel, is 1 to 200 g/l, preferably 10 to 50 g/l.

The application of the preparation to at least one surface of an article can be accomplished in any way known to a person skilled in the art. With preference the preparation is applied by immersing the article in the preparation, by brush application, by roller application using a fleece roller, or by spray application of the preparation to the article.

The spraying of the preparation can be accomplished preferably with a pressure of 1 to 5 bar.

The method of the invention can be used to produce articles treated on at least one surface with an anti-fouling coating.

The article to be coated may be made, for example, of metal, plastic, wood, ceramic or glass.

Features of the coating of the invention are that it has a microroughness, which gives it a matt appearance when viewed in air, and that it is initially not fully wetted by water. Initially, instead, a ternary solid/liquid/gaseous phase boundary exists on the surface of the article. After a certain dwell time, dependent on factors including the hydrostatic pressure and amounting to a time of hours to days, but not critical to the invention, this phase boundary undergoes transition to a fully wetted state. After that there is only a solid/liquid phase boundary. This remains in existence, even if the coated article is brought temporarily into contact with a gas phase, air for example. This distinguishes the coating of the invention not only from a conventional coating but also from an ideally superhydrophobic coating.

A further feature of the coating of the invention is that it remains adhering permanently to the article in flowing water, under mechanical load such as rubbing, or under a high-pressure water jet.

The invention further provides for the use of the coating of the invention for the anti-fouling treatment of surfaces standing in contact with water.

The invention has the advantage that articles of all kinds can be treated with an anti-fouling, physiologically unobjectionable, permanent coat in a simple way.

### EXAMPLES

### Example 1

100 g of a polyacrylate binder based on isobutyl methacrylate and relatively long-chain methacrylates are stirred lump-free into 500 g of commercially customary nitrocellulose thinner, giving a clear solution.

130 g of AEROSIL R 812S are added in portions to this solution with stirring. When the powder has been incorporated lump-free, homogenization is brought about by further stirring at 3000 rpm for 10 minutes more. This is followed by letdown with 1000 g of nitrocellulose thinner.

Following application to a surface and evaporation of the solvent, a permanent water-repellent coat is formed.

### Example 2

100 g of a polyacrylate binder based on isobutyl methacrylate and relatively long-chain methacrylates are incorporated lump-free into 500 g of nitrocellulose thinner, giving a clear solution. Subsequently 130 g of AEROSIL R 8200 are added with stirring. When the preparation has been incorporated lump-free, homogenization is brought about by further stirring at 3000 rpm for 10 minutes more. Letdown is carried out with a further 780 g of nitrocellulose thinner. Following application to a surface and evaporation of the solvent, a permanently adhering water-repellent coat is formed.

Test methods: The preparations of Examples 1 and 2 are applied in sections to the underwater hull of a sailing boat. The application rate is such that there is on average 0.25 g of the hydrophobicized silicon dioxide per m² of coated surface. After complete drying, the coatings of Examples 1 and 2 are completely water-repellent under atmospheric conditions. The boat is placed in water and remains for 3.5 months in the Baltic Sea water. After this time it is brought onto land and inspected for infestation by marine organisms.

It is found that the entire area treated is fully wetted. The zones coated with the preparations of Examples 1 and 2 had the typical fouling which was also seen on boats of the same size that had spent the same time in the same bodies of water. However, the removal of the fouling required less force to be applied and took up only a quarter of the time, as compared with the cleaning of surfaces bearing only the usual antifouling paint.

1. An anti-fouling coating consisting of a resinous binder layer comprising nanoscale hydrophobic particles, wherein
the particles are not only located in the binder layer but also protrude from it,
the particle/binder ratio is 2.5 to 5, and
the particle concentration of the binder layer is 0.01 to 1 g/m².

2. The anti-fouling coating according to claim 1, characterized in that the thickness of the binder layer, including the particles protruding from it, is 0.1-100 μm.

3. The anti-fouling coating according to claim 1, characterized in that the nanoscale hydrophobic particles have a BET surface area of 10 to 400 m²/g.

4. The anti-fouling coating according to claim 3, characterized in that the particles are pyrogenically produced metal oxide particles.

5. A method of producing the anti-fouling coating according to claim 1, characterized in that a preparation comprising nanoscale hydrophobic particles and at least one binder is applied to at least one surface of an article and then cured.

6. The method according to claim 5, characterized in that the fraction of nanoscale hydrophobic particles is 0.5% to 15% by weight, based on the total amount of the solid and liquid constituents of the preparation.

7. The method according to claim 5, characterized in that the preparation comprises a propellant gas.

8. The method according to claim 6, characterized in that the preparation is applied to the base layer by spraying.

9. A method for the biostatic treatment of surfaces standing in contact with water comprising applying to said surfaces the coating according to claim 1.
